(19) United States
(12) Patent Application Publication
(10) Pub. No.: US 2025/0119400 A1
(43) Pub. Date: Apr. 10, 2025

(54) DEVICE PROXIMITY-BASED COMMUNICATION SYSTEMS AND METHODS

(71) Applicant: Aztecho LLC, Wellington, FL (US)

(72) Inventor: Jacobo Bacariza, Miami, FL (US)

(73) Assignee: Aztecho LLC, Wellington, FL (US)

(21) Appl. No.: 18/910,834

(22) Filed: Oct. 9, 2024

Related U.S. Application Data
(60) Provisional application No. 63/589,228, filed on Oct. 10, 2023.

(51) Int. Cl. H04L 51/222; H04W 4/029; H04W 4/12

(52) U.S. Cl. CPC H04L 51/222; H04W 4/029; H04W 4/12

(57) ABSTRACT

Systems and methods include a proximity-based communication system to establish anonymous, non-persisting communication sessions between various clients based, at least, on their proximity to one another. A device location may be determined and then, based on that location, a communication area may be established. For other users within the communication area, the device may be provided with an option to form communication sessions with eligible users and, upon completion of the communications or movement away from the communication area, the messages within the communication sessions may be deleted.

### CROSS-REFERENCE TO RELATED APPLICATIONS

This application claims priority to and the benefit of U.S. Provisional Patent Application No. 63/589,228, titled “DEVICE PROXIMITY-BASED COMMUNICATION SYSTEMS AND METHODS,” filed Oct. 10, 2023, the full disclosure of which is hereby incorporated by reference in its entirety for all purposes.

### BACKGROUND

### 1. Field of Disclosure

Embodiments of the present disclosure relate to communication systems for connecting devices for communications based, at least in part, on proximity. More particularly, systems and methods are directed to proximity-based group communication systems that maintain user privacy information.

### 2. Description of Related Art

Existing communication systems, such as those that allow users of mobile devices to connect or chat with one another, are generally location based according to an input provided by a user or by detecting a user location. Upon determination of a location, these systems may enable a user to connect with and communicate with other users within a given proximity, which may be filtered or otherwise restricted by the user. However, existing systems are slow to update a user's location and may base the location services on an initial or “home” location, rather than a current location. As a result, communications may not accurately reflect the user's location and associated communication partners. Additionally, these systems maintain records of the communications and may not provide sufficient anonymity.

### SUMMARY

Applicant recognized the problems noted above herein and conceived and developed embodiments of systems and methods, according to the present disclosure, for proximity-based communication systems.

In an embodiment, a computer-implemented method includes receiving a request to establish a communication session from a device. The method also includes determining, for the device, a device location. The method includes determining, based at least on the device location, a communication area for the device. The method further includes providing, for display on the device, one or more session options associated with the request, each session options of the one or more session options corresponding to a communication session. The method includes receiving, from the device, a selected option from the one or more session options. The method also includes establishing a connection between the device and the selected option. The method further includes receiving, from the device, a message associated with the connection and the selected option. The method includes causing the message to be displayed for users of the selected option. The method further includes receiving, from the device, an ending indication for the communication session. The method also includes deleting the message from the selected option for the device and associated devices of the users of the selected option.

In another embodiment, a method includes determining a device location for a device participating in a proximity-based communication session. The method also includes determining, for the communication session, a connection parameter for participants of the communication session. The method further includes determining the device location fails a condition associated with the connection parameter. The method includes disconnecting the device from the communication session. The method also includes deleting messages associated with the device from the communication session.

In an embodiment, a computer-implemented method includes receiving a first request to establish a communication session from a device. The method also includes determining, for the device, a device location. The method further includes determining, based at least on the device location, a communication area for the device. The method also includes establishing, for the device, a session option to be used by additional devices within the communication area. The method includes receiving, from a first additional device, a second request to connection to the session option. The method further includes, establishing a first connection to the first additional device. The method also includes receiving from a second additional device, a third request to connect to the session option. The method further includes establishing a second connection to the second additional device. A first additional device communication area is within the communication area, a second additional device communication area is within the communication area, and the first additional device communication area and the second additional device communication area do not overlap.

In an embodiment, a system includes one or more processors to receive a first request to establish a communication session from a device; determine, for the device, a device location; determine, based at least on the device location, a communication area for the device; establish, for the device, a session option to be used by additional devices within the communication area; receive, from a first additional device, a second request to connect to the session option; establish a first connection to the first additional device; receive from a second additional device, a third request to connect to the session option; and establish a second connection to the second additional device. A first additional device communication area is within the communication area, a second additional device communication area is within the communication area, and the first additional device communication area and the second additional device communication area do not overlap.

### BRIEF DESCRIPTION OF DRAWINGS

The present technology will be better understood on reading the following detailed description of non-limiting embodiments thereof, and on examining the accompanying drawings, in which:

FIG. 1 illustrates an environment for establishing one or more communication sessions, in accordance with embodiments of the present disclosure;

FIG. 2A illustrates an example configuration for identifying clients within associated communication areas, in accordance with embodiments of the present disclosure;

FIGS. 2B-2E illustrate example communication session configurations for different communication areas, in accordance with embodiments of the present disclosure;

FIG. 3 illustrates an example configuration for identifying clients within associated communication areas, in accordance with embodiments of the present disclosure;

FIG. 4A illustrates an example flow chart of a process for establishing a communication session, in accordance with embodiments of the present disclosure;

FIG. 4B illustrates an example flow chart of a process for maintaining a communication session, in accordance with embodiments of the present disclosure;

FIG. 5 is an example configuration for a computing device, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Like numbers may be used to refer to like elements throughout, but it should be appreciated that using like numbers is for convenience and clarity and not intended to limit embodiments of the present disclosure. Moreover, references to “substantially” or “approximately” or “about” may refer to differences within ranges of +/−10 percent.

Embodiments of the present disclosure are directed toward systems and methods for enabling anonymous location-based communication services in which a present device location is used to establish a communication distance for permitting or otherwise establishing connections to other users of a service. A device location may be determined and used to set a radius, fence, or any other distance-representation around a present location of the device and/or to determine whether the device is within a specified location for the service and may then enable communications with one or more additional devices that fall within the radius or fence of the device location and/or with one or more additional devices having a respective radius that includes the user device. Moreover, devices within a given specified location may also be permitted to communicate with one another, for example, as part of an established service or offering. While the devices are within a given area or range, one or more private communication services, such as a chatroom, may be established in which users may communicate with one another. In various embodiments, chatrooms can be open or global (e.g., available to all users within a given area) or may be closed or private (e.g., open to select individuals, direct messages, etc.). It should be appreciated that closed or private chatrooms may have different access control levels based on one or more settings established by a creator of the closed or private chatrooms. For example, a user may create a private chatroom and then set a certain radius for the chatroom. As another example, an entity, such as a university library, may create a closed or private chatroom that only permits access for devices on a certain floor or within a given area, among other options. Communications may be anonymous within the chatroom unless users elect to provide identifying information, for example within private chats directly between users. Upon leaving the area or range, the user may be removed from the chat and a history of the chat may be deleted and/or removed from the user device and/or other devices associated with the chat, thereby maintaining privacy for the users and only permitting interactions when users are within a set or given radius. In this manner, users may anonymously interact within a given range, for example at an event, school, business, or resort location, and then end the chat by leaving the area.

Various embodiments of the present disclosure may be executed on a mobile device as an application that uses location services to establish an area of communication between various users of the application. In at least one embodiment, different levels or tiers of service associated with the application may be provided to enable users to adjust their location settings (e.g., increase a radius, decrease a radius, etc.) or establish different communication preferences (e.g., create a roomchat, send a private message, etc.). Users may pay a fee to have higher levels of service, where one or more additional features may be enabled at higher tiers. By way of example, a radius for communications may be increased for higher tier users, additional messaging capabilities may be enabled for higher tier users, options to create private chatrooms and/or moderate those chatrooms, and/or the like. A user device may serve as a “fixed point” for a given location service and then a radius or other measure may be used to establish an area of communication in which the application can participate in conversations and/or send/receive messages from other users within the area of communication. Moreover, users may elect to join a chatroom or other communication area, which may be referred to as a “global” or “public chat” in which each user within a given area may participate and communicate with others. In at least one embodiment, global or public chatrooms may be established by one or more entities associated with the location, such as a resort owner establishing a public chatroom for guests at the resort or a concert purveyor may establish different public chatrooms around different stages at a music festival, among various other options. The communication within the global chatroom may be anonymous and, as noted herein, may be deleted once a user leaves the area of communication.

Systems and methods may be used to establish different types of communications between various users that permit anonymous participation and/or monitoring of a set of messages, for example, within a global chatroom. The user may elect to enter the global chatroom and then choose whether or not to participate, such as by submitting different chat messages (e.g., textual messages, audio messages, video messages, and/or combinations thereof). In at least one embodiment, users may be provided with an indication related to a number of users within the area of communication, a number of users within a given chatroom, a number of users actively participating in a given chatroom, or various combinations thereof. Furthermore, in at least one embodiment, users may be provided with additional information associated with how users are interacting with one another, such as indications of which users can “see” or communicate with others within a global chatroom, as will be described herein.

Various embodiments may be deployed to enable anonymous communications between users within a given area associated with different events and/or particular locations. By way of non-limiting example, large events such as music festivals, sporting events, conferences, and/or the like may establish different chatrooms for participants (e.g., users within a given area of communication associated with the event) to communicate with one another and/or to receive messages from different participants and/or organizers. For example, at a music festival, fans of a particular band may enter a chatroom to discuss the band, receive offers associated with merchandise for the band, and/or make plans to meet up and enjoy a performance together. Furthermore, different areas of the festival grounds may have different group chatrooms for different users to enter, communicate with fellow festival participants, and make plans or receive additional information. In various embodiments, participation in these group chatrooms may be provided using one or more location services, as noted herein, where a user may gain access by being within a certain proximity to a stage or within a geofenced location. As another example, participants at a conference may join a chatroom for a certain product or service to get news about the product or exhibits associated with that product, receive advertisements or coupons, and/or the like. In certain embodiments, the participants may be granted access to different public chatrooms based on their participation with the conference, such as by connecting to a wireless network associated with the conference. Similarly, as a further example, at a political event persons associated with particular candidates may meet within chatrooms in order to discuss their preferred candidate. In this manner, the user may elect a level of participation while they are within the area of communication and then may leave the area to halt the communications and/or may decide to leave the chatroom while still in the communication area. In at least one embodiment, users may provide permission to receive messages from particular events or providers upon entering a given area. For example, an advertising service may provide the user with information regarding available products or services while a user is within an area, provide the user with coupons or other special offers, and/or provide suggestions for activities, among various other operations.

Embodiments of the present disclosure may also be used to send private messages between two or more users. For example, users may establish a private two-way chat or a private chatroom, such as one that requires permission or other access credentials to enter, such as an invitation from an administrator. Private messages may be provided within an inbox and may have a life expectancy, such as 24 hours, after which the message will be deleted, regardless of whether or not the users are still participating. As a result, users using the private messages may be encouraged to exchange alternative contact information (e.g., a phone number, a social media handle, etc.) or complete their interaction within the given period of time. In certain embodiments, messages may be deleted within a period of time even if the recipient has not opened the message. Accordingly, systems and methods may encourage more active participation with private messages by setting a time limit for interaction, thereby prompting the user to check their messages and respond more often.

Systems and methods of the present disclosure may use one or more location-based services in order to identify a position of a device associated with an executing application, establish an area around the device (e.g., a radius) for permitting communications, identify other associated users within the area around the device, and then provide access to one or more communication systems, such as a chatroom, to enable anonymous communications with others within the area. The application may be associated with an authenticated user that provides credentials (e.g., a user name, a password, etc.) where, in various embodiments, identifying information may not be permitted when establishing the user name. Upon entering a chatroom, the user may or may not have access to previous messages within the room, for example based on various messaging criterion for the room, and may also interact with other users within the room. As one or more users within the chatroom leave the area, their messages may be removed from the chatroom, while others may persist for as long as the user remains in the area and/or maintains a connection to the application. Accordingly, systems and methods permit anonymous interactions between users within a given area and then delete or otherwise remove chat information, thereby increasing privacy by not collecting and maintaining private information and also not storing messages between various users.

Embodiments of the present disclosure may enable one or more users to establish private and/or semi-private chatrooms within a given area. For example, a user may establish a chatroom while at a coffee shop and set a radius for participation within the chatroom. As other users enter the coffee shop, they can choose to enter and/or participate in the chatroom or not. In certain embodiments, participation within the chatroom may provide other participating users with the benefit of interacting with additional users. For example, if a first user has a first radius of participation and a second user has a second radius of participation that is greater, due to be at a higher tier, the second user can establish a chatroom that would enable more people to join than one set up by the first user. By entering the chatroom of the second user, the first user may be permitted to interact with other users within the chatroom, even if those users would otherwise be outside of a communication area for the first user. In this manner, the establishing user may “anchor” or otherwise establish the communication area for all users within the chatroom and may therefore boost or increase a number of users that can interact with one another. Moreover, in one or more embodiments, the user that created the chatroom may also have additional options to moderate or otherwise control participation and entry. For example, if a person were to enter and be disruptive, the creator of the chatroom would have the option to remove the disruptive user from the chatroom and/or block the disruptive user from re-entering the chatroom.

Systems and methods of the present disclosure may enable users within one or more overlapping communication areas to participate in communication services with one another. The communication areas may be based, at least in part, on a respective user location and a distance away from the user (e.g., a radius). When communication areas overlap, then users may have access to different forms of communication, such as group chats, private chats, semi-private chats, direct messages, and/or combinations thereof. In various embodiments, communication areas may be established individually by the users and/or by a provider at a location, such as a convention setting a certain floor or area of a convention hall to be a public chat area. In this manner, users may interact with those in close proximity to them and then the communications and associated records may be deleted when users move away from one another.

Various other such functions can be used as well within the scope of the various embodiments as would be apparent to one of ordinary skill in the art in light of the teachings and suggestions contained herein.

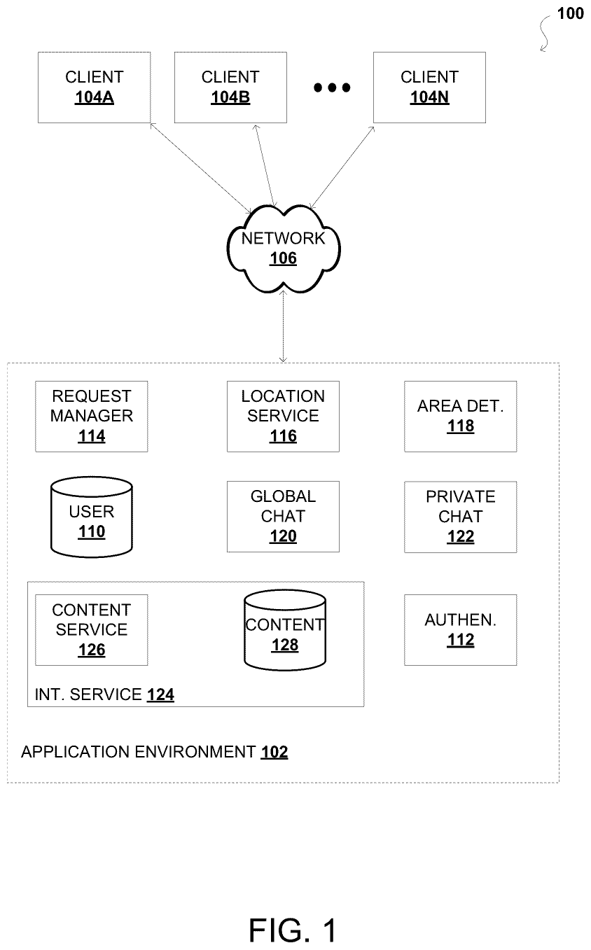

FIG. 1 illustrates an example environment 100 that may be used with embodiments of the present disclosure. In this example, an application environment 102 (e.g., application engine) may be used to provide access to various resources to execute various functionality described herein. Systems and methods may be directed toward one or more applications, such as those executing on processors according to instructions stored on memory, on one or more client devices to provide communication services, such as chat services. As discussed herein, various features of the application environment 102 may be executed responsive to permissions provided by the user, for example permissions to access location services for a given device and/or permission to receive messages.

In operation, one or more clients 104A-104N (e.g., users) may submit requests over one or more networks 106 to access and/or use features associated with the application environment 102. The clients 104A-104N may be represented by one or more client devices (e.g., client computing devices), which may serve as a proxy to the client/user by making requests responsive to one or more input commands. Additionally, a client may navigate to one or more applications or access points using the device to submit a request, among other options. As another example, a request may be transmitted as part of an automated or semi-automated work flow, which may or may not receive user interaction. Accordingly, one or more client computing devices, associated with the clients 104A-104N may be used with direct input from one or more users, from stored software instructions, from executions of various workflows, or combinations thereof. For example, one type of request from the clients 104A-104N may be a user requesting to enter a chatroom and/or a user providing credentials, among various other options. However, an automated request may be associated with a workflow that transmits, responsive to instructions, one or more automated communications to users within a chatroom, such as a coupon for a special offer associated with the location associated with the users of the chatroom.

In at least some embodiments, requests may include a request to interact with one or more users, such as instructions to enter a message (e.g., a textual message, a video message, an audio message, etc.) into a chatroom, which may be a publicly established chatroom, a semi-private chatroom, and/or a private chatroom, among various other options. The network(s) 106 can include any appropriate network, such as the Internet, a local area network (LAN), a cellular network, an Ethernet, or other such wired and/or wireless network. Furthermore, the application environment 102 may be associated with various resource provider environments, such as those that provide distributed computing services, which may include any appropriate resources for providing content and/or services, as may include various servers, data stores, and other such components. In various embodiments, the client devices can be any appropriate computing or processing device, as may include a desktop or notebook computer, smartphone, tablet, wearable computer (i.e., smart watch, glasses, or contacts), set top box, kiosk, interactive display, or other such system or device.

One or more requests may be submitted over the network 106 to be received at the application environment 102, for example at an interface layer that may service as a landing page or application program interface (API) to access different resources and/or content elements. User credentials may be checked prior to granting access to the content or resources within the application environment 102, for example using one or more user datastores 110 that may store user information for a given service associated with the resource environment 102. An authentication service 112 may be associated with the datastores 110 to verify different access credentials, such as a user name, password, and/or the like. Furthermore, in at least one embodiment, the authentication service 112 may also be used to establish new accounts for new users. For example, the authentication services 112 may receive a request to establish a new account and then receive information associated with the new account, such as a desired user name and/or password. In at least one embodiment, the user name may be evaluated to determine whether or not the user name satisfies different anonymity criterion. For example, the user name may be compared to the user's name to ensure that elements of the user's name are not present in the user name, thereby increasing security and providing improved anonymity with using the application. As another example, additional identifying information may be checked and compared, such as a social media handle (e.g., Instagram handle, Twitter handle, Snapchat handle, etc.), digits of a phone number, physically identifiable information, and/or the like. Additionally, a digital avatar of the user may be evaluated for removal of identifying information, such as not permitting the user to put a photograph of themselves within a profile or as a chat icon. In this manner, users may choose only particular times to share personally identifying information with other users. Furthermore, in at least one embodiment, the user name may be permitted to be whatever the user wishes (within one or more criteria associated with various terms of service) and then an anonymized user name that is present to other users may be automatically generated. By way of non-limiting example, a user may select a user name such as firstname_lastname for log in purposes, but when the user interacts within the application, a random name may be generated for them (e.g., user1346342), thereby increasing their anonymity. In this manner, log in may be simplified for the user while preserving their privacy.

A request manager 114 may receive input from the various clients 104A-104N and may route them to one or more systems and/or sub-systems for processing and execution. For example, a request to log in may be routed to the authentication service 112 and, upon successful authentication, a location service 116 may be used to determine a location of the device associated with the client 104A-104N. For example, the location service 116 may access one or more features of the device, upon receiving permission from the user, such as a global positioning system (GPS) receiver, a Bluetooth receiver, a Wi-Fi receiver, a Near Field Communication (NFC) transceiver, and/or the like in order to determine a location of the device. This location may be provided to an area determination service 118 that is used to establish an area around the device for interaction. The area may be based, at least in part, on the associated service used to identify the device location. For example, geofencing may be used to establish a virtual perimeter associated with a physical geographic location. As another example, the location of the device may be a point and then a radius around that point may be established as a communication area. Furthermore, by way of further non-limiting example, being within a threshold distance of a Bluetooth connection and/or NFC connection may establish the area for the device. It should be understood that a variety of different positioning methods may be used, individually or in combination, in order to establish a communication area for a given device. For example, assisted GPS may be used in combination with GPS. Similarly, Wide Area Augmentation System (WAAS) may also be used. Additionally, one or more additional features or protocols may be used. For example, radio frequency identification (RFID) or other NFC protocols may be used to determine whether a device is within a given area, such as scanning the device upon entry of one location and then scanning upon exit, thereby indicating that the user will be leaving a given area.

Systems and methods of the present disclosure may use one or more artificial intelligence (AI) and/or machine learning applications in order to receive/send requests and/or to establish the location of the device via the location service 116 and/or the determination service 118. For example, one or more machine learning algorithms may be used to establish different communication pathways between different users, which may include switching between different servers based on location, switching between connections based on anticipated latency, and/or combinations thereof. For example, one or more machine learning systems may be used for load balancing in order to effectively route requests and/or connections between users, such as placing requests on a server closer to the users so that latency is reduced. Additionally, one or more machine learning systems may be used to monitor bandwidth or latency of various network connections and then intelligently switch connections. In at least one embodiment, machine learning applications may also improve the accuracy of different location determination services. For example, one or more geospatial solutions may be used to map, visualize, and/or interact with a variety of datapoints to improve precision of location for different location-based applications. As a result, higher precision location services may enable for improved establishment of communication areas, and as a result, improved user experiences.

In at least one embodiment, the location service 116 and/or the area determination service 118 may be either active or passive. While active services may consume more memory or battery, such a system may establish a current location for the device (e.g., a location obtained in real or near-real time) to enable rapid updates of the communication area, which may affect which users may be in contact with one another. As a result, the location service 116 may be used to update the location of the device at different intervals of time (e.g., substantially continuously, every minute, every five minutes, etc.). In at least one embodiment, one or more machine learning algorithms may be deployed to use the information from the location service 116 to refine a determination of the current location for the device. Similarly, the service may be active only for a given period of time (e.g., to scan upon entry, connect to a Wi-Fi network, etc.) and then assume the user remains in the area until another action (e.g., scan upon exit, disconnect from a Wi-Fi network, etc.) is performed. As a further example, a user may be assumed to be within an area during a period of time, such as a period of time associated with a reservation at a resort or other location, and as a result, upon check in the user may be added to a given communication area and remain in the area for the duration of their stay (e.g., removed at check out). In a further example, systems and methods may be paired or otherwise integrated into applications associated with other locations and the user may provide an indication in another application that they are at an area and the location service 116 may use that information to establish the communication area. For example, if a user is at a theme park and they use the theme park's application to indicate they are waiting in line for a ride, the location information may establish an area around the ride as the communication area and the user may be permitted to chat with other users in the same area, for example in a semi-private chatroom and/or public chatroom that is established and/or controlled by the theme park operator. These chatrooms may be referred to as “permanent private chatrooms” in that they have restricted access (based on the particular location) but may remain active without a central device because the communication area may be pre-established by an administrator.

Various embodiments of the present disclosure may be associated with one or more interactive features of the application environment 102, such as a chat service that enables users within a given area (e.g., overlapping communication areas, presence within a communication area, etc.) to communicate with one another through one or more chatrooms (e.g., chats, rooms, etc.) and/or the like. In at least one embodiment, a global chat feature 120 is used to establish chat capabilities for users within a certain range of one another such that their respective communication areas overlap and/or each user is deemed to be within a common communication area. The global chat feature 120 may be controlled by the application environment 102 and/or by one or more users with sufficient permissions, such as a host that is associated with a given area associated with an event. The global chat may be a public chatroom where each user within the given area may have the option to enter and participate in conversations with others. Similarly, a private chat feature 122 may enable one or more users, organizations, providers, and/or the like to establish private chatrooms, which may include direct communication with groups of users and/or a chatroom that various users may enter upon receiving permission. Moreover, as noted above, different settings for the private chat feature 122 may allow for semi-private chatrooms. By way of example, a private chatroom may require a direct invitation from the creator. In contrast, a semi-private chatroom may be established by a user in a given location that permits anyone within a communication area to enter the chatroom, where the communication area may be established by the creating user. Thereafter, use of the private and/or semi-private chatrooms may be coordinated by the creating user, such as to moderate participation, extend additional invitations, block users, and/or the like. In this manner, users may choose how they interact with one another and their own level of involvement with the interactions.

Various embodiments may also be used by one or more hosts or authorized parties to provide interactive services and/or support to different users within a given area. For example, an interaction service 124 may be used to interact with different users within a given communication area, such as by providing notifications or information for a given event or upcoming activity, providing coupons or advertisements, and/or the like. A content service 126 may be used to select different content elements from a content datastore 128 for distribution to the different users, for example through a global chatroom established by the global chat service 120. As a result, users of the service may receive coupons, news, advertisements, alerts, notifications, and/or other information that others may not receive. Additionally, the interaction service 124 can also be associated with a given event or area, such as a resort, which may be used to provide updates on activities to various users, among other features.

Embodiments of the present disclosure may be used to provide systems and methods to enable communications between different groups of users, where the communications may be anonymous and/or not persistently stored after completion. For example, upon existing a chatroom and/or leaving a communication area, a user's interactions within the chatroom may be deleted from both the user device and from the remaining devices associated with the chatroom, thereby increasing anonymity and security within the chatroom. In this manner, a user may choose to interact while in a given area and then leave the area to end the interactions.

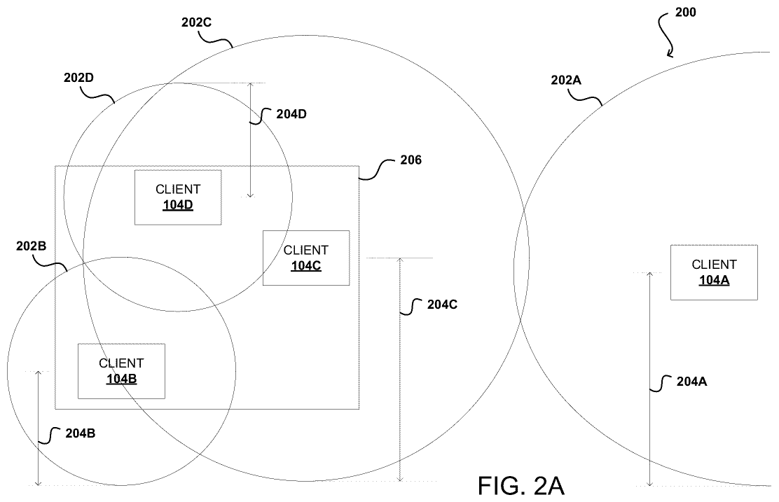

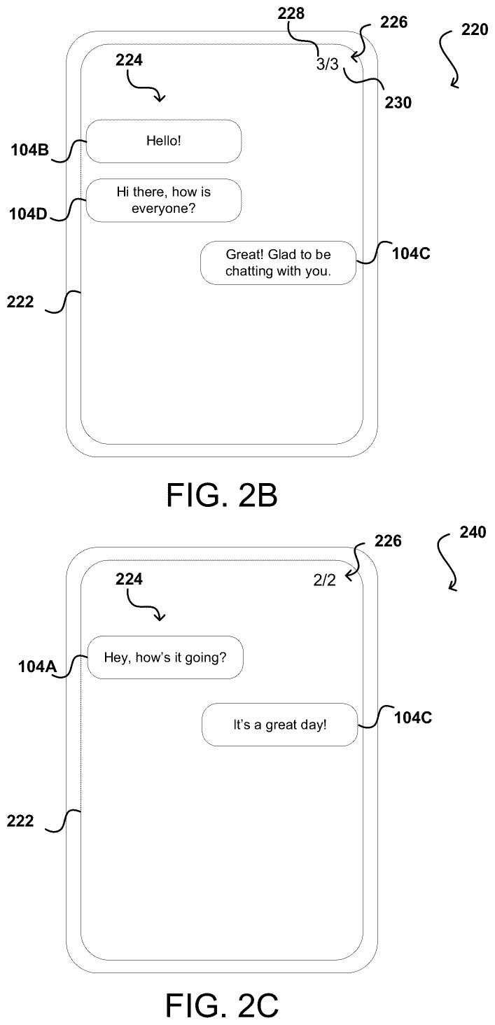

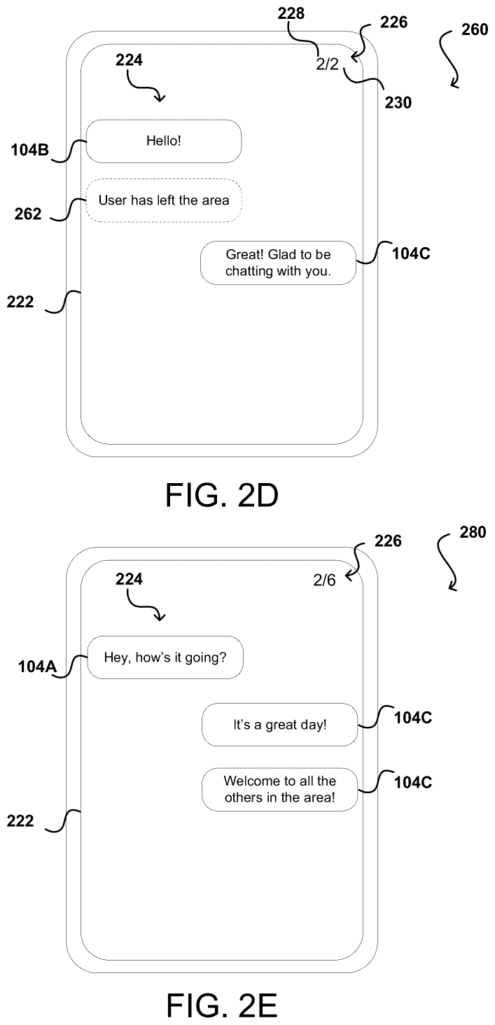

FIG. 2A illustrates an example configuration 200 that may be associated with embodiments of the present disclosure. In this example, four clients 104A-104D (e.g., users 104A-104D) are using devices that enable determination of respective communication areas 202A-202D for each of the users 104A-104D. The communication areas 202A-202D, as noted herein, may be determined based, at least in part, on location information provided by the users 104A-104D which may then establish a communication area. In this non-limiting example, the communication area may be associated with a radius extending outwardly from the clients 104A-104D, respectively. However, it should be appreciated that other features or information may be used to establish the respective communication areas 202A-202D. As will be appreciated, the communication areas 202A-202D may shift and move as the device moves. For example, if the client 104A is walking along a roadway, the communication area 202A will move as the client walks. That is, in various embodiments, the communication areas are dependent on a location of the clients 104A-104D and/or their associated devices.

As shown, different communication areas 202A-202D may be sized differently. That is, a communication area radius 204A-204D (in this non-limiting example that includes a radius) may be different depending on one or more parameters, such as a user selection and/or a user tier. For example, a user may be provided with an option to select a given radius. In various embodiments, users may sign up for a subscription service that, at higher tiers, may allow the user a larger range and/or to perform other actions, such as to establish private chatrooms, among other options. In this example, the client 104C has a larger communication area 202C than the clients 104B, 104D. As a result, the client 104C may have access to communication with a greater number of users.

In this example, different communication scenarios may be presented for different clients based, at least in part, on their respective communication areas. For example, in this example, the communication area 202C of the client 104C overlaps with the communication areas 202A, 202B, 202D. However, the communication area 202A only overlaps with the communication area 202C. Additionally, in this example, both of the communication areas 202B, 202D overlap with one another and with the communication area 202C. Accordingly, different public chatrooms may provide access to different users. That is, a first public chatroom may only include the clients 104B-104D while a second public chatroom may only include the clients 104A, 104C. In other words, the client 104C has the option to talk to all of the other users, while the others users do not.

Systems and methods may also enable the client 104C to establish their own private or semi-private chatroom that would permit communication between the clients 104B, 104D and the client 104A, even when the client 104A is outside of the respective communication areas 202D, 202B. For example, the client 104C may establish a private or semi-private chatroom in which the communication area for the chatroom is determined by the individual client 104C. That is, the particular private and/or semi-private chatroom may permit entry to any user within the communication area 202C and/or any user with a respective communication area 202 that overlaps with the communication area 202C. Moreover, once the user is within the private and/or semi-private chatroom created by the client 104C, they may be permitted to communicate with one another as long as they remain within and/or overlapping with the communication area 202C. In this manner, the communication area 202C for the client 104C may “control” or otherwise establish which users are in communication with one another. In certain embodiments, users can enter public or group chatrooms and then broadcast or otherwise send invitations to their own private and/or semi-private chatrooms.

Various embodiments may also enable one or more establishments or areas to set up their own private and/or semi-private chatrooms. These regions may be permanent and/or semi-permanent for a given location. For example, if the clients 104B-104D are all within a coffee shop, the proprietor may have a coffee shop communication area 206 that is static and only covers their particular location. As a result, when users enter the coffee shop, they may receive notifications that they can enter the coffee shop chatroom to communicate with other patrons. In various embodiments, the coffee shop communication area 206 may be a geofenced location that permits any user within the area to enter the chatroom. In other embodiments, user location may be determined by connecting to the coffee shop Wi-Fi network or by scanning a code upon entry or using an application on their phone to order and/or pay at the coffee shop. As a result, users may have a variety of options for communicating with different persons based on their location.

FIGS. 2B and 2C illustrate example chat configurations 220, 240 that may be used with embodiments of the present disclosure, such as for the configuration 200 in FIG. 2A. In this example, the first configuration 220 includes each of the clients 104B-104D, in accordance with the overlapping communication areas 202B-202D illustrated in FIG. 2A. As a result, each of these clients 104B-104D may enter a public chat area 222 and exchange messages 224 within a given public chatroom. In this example, the messages associated with the viewer may be on a right hand side, while the messages associated with others in the chat are on the left hand side, but such a configuration is provided by way of non-limiting example and the messages may be provided in a variety of other configurations. Furthermore, each message 224 may be marked or otherwise include an indication regarding one or more users that sent the messages, such as a user name or an auto-generated identification. Additionally, further identifiers may be provided, such as an icon to illustrate a tier of the user, an icon to illustrate the user is open to receive private messages, and/or the like. These identifiers may be referred to as passive visual identifiers in that they may be part of the message and users will understand their meaning without directly interacting with the identifiers. For example, a user may have a passive identifier indicating they are unwilling to receive private chatroom requests, and as a result, another active user will know not to send such a request to the user. Moreover, in various embodiments, the messages 224 may include no identifying information and may appear as messages alone, thereby increasing anonymity and privacy. In certain embodiments, messages may appear without identifiers for a streamlined look and then a user can choose to obtain more information, such as by clicking and holding on the message to pull up profile information for the user. The profile information may include a message blurb about the user, an indication of which users the user can see based on their tier level, and/or the like. In at least one embodiment, a chat indicator 226 may be included to illustrate a number of participating users 228 compared to a number of total eligible participants 230. In this manner, the participating users may reach out to other users, who may be viewing the chat or are unaware of it happening, to participate and interact. The configuration 240 of FIG. 2C includes fewer users, as shown by the chat indicator 226, and this example only includes the clients 104C and 104A due to the overlapping areas 202A, 202C shown in the configuration 200 of FIG. 2A. As a result, the chat of configuration 240 is not visible to the clients 104B, 104D. However, as noted herein, the clients 104B, 104D could communicate with the client 104A in the event that the client 104C established a private and/or semi-private chatroom using the communication area 202C as the communication to permit access to the chatroom.

FIGS. 2D and 2E illustrate example chat configurations 260, 280 in which one or more clients has moved beyond the communication areas that permitted the chat initially. For example, in FIG. 2D the client 104D has left an area that created overlap with both of the clients 104B and 104C, and as a result, only the clients 104B and 104C remain. In this example, the message 224 sent by the client 104D is now deleted, with a notification 262 indicating that the user that provided the message has left the area and is no longer eligible to chat. As noted herein, the message 224 is now no longer available to either the client 104D or the other clients 104B, 104C in the chatroom 222.

FIG. 2E illustrates the example chat configuration 280 in which additional potential users have entered the area, but are not participating in the chatroom. For example, these users may not be aware that the chat is going on. In this example, the client 104C is trying to get them to engage in the conversation. For example, if a user has elected to receive notifications from the application, they may receive an indication that a public chatroom is available in their area and may then elect to participate and/or observe the chatroom.

Embodiments of the present disclosure may also provide options to interact with various users through messages transmitted via the chatrooms and/or private messages. By way of example, users can interact with messages by clicking or otherwise selecting one or more interactive icons, which may include the message itself, a profile picture, a separate icon, and/or the like. Furthermore, different interactions may change the information presented. For example, clicking and holding may provide additional or different information when compared to clicking for a short period of time or double clicking. As further non-limiting examples, clicking down on a message of any user in any chatroom may present options such as: Report (such as to report the user's conduct), DM (direct message, which may further provide a link or a screen associated with an inbox or private messaging service), Invite to private room (which may be a separate notification provided to the user which has a period for reply, such as but not limited to 15 minutes), Mute (to not see messages from a particular user for a period of time, which may reset after a period, where the mute can be tuned to particular chatrooms and/or be extended across all chatrooms), Block (with the option to view blocked users and then unblock), Highlight (allow the user to see the messages of the user they highlighted for a longer duration during high traffic chats and will send them notifications of their messages), among various others.

Various embodiments of the present disclosure may wish to encourage participation by not including, within public chats, messages for each user. For example, returning to FIG. 2A, in a global public chatroom, messages sent by the client 104A would not be visible to the clients 104B, 104D. In other words, the client 104A may “miss out” on other conversations by not being in proximity of other users. This type of configuration enables the chatrooms and communications to remain within small areas. For example, if the group chat was expanded to include the communication area 202A, then a user that is well away from the area of the clients 104B, 104D may be included within the chat. Accordingly, if it was desirable to add in the client 104A, then the client 104C would need to establish the private and/or semi-private chatroom to set their particular communication area 202C as the radius, which would then include all users within the communication area 202C, even if those users were unable to communicate in public chatrooms.

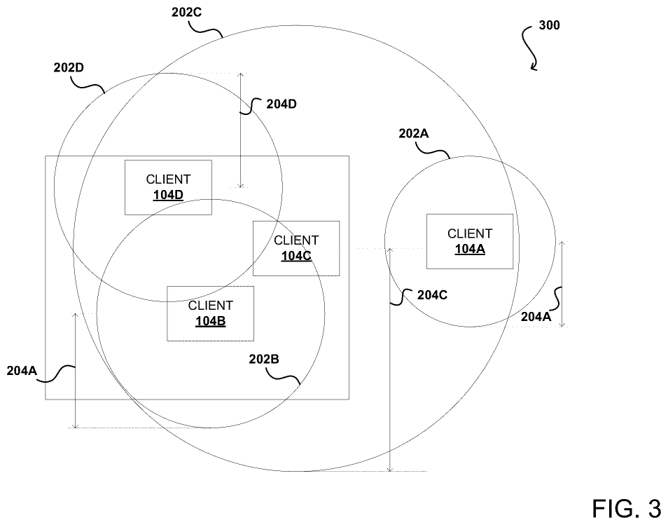

FIG. 3 illustrates an example configuration 300 that may be associated with embodiments of the present disclosure. In this example, four clients 104A-104D (e.g., users 104A-104D) are using devices that enable determination of respective communication areas 202A-202D for each of the clients 104A-104D. The communication areas 202A-202D, as noted herein, may be determined based, at least in part, on location information provided by the clients 104A-104D which may then establish a radius or other feature to establish the respective communication areas 202A-202D. As will be appreciated, the communication areas 202A-202D may shift and move as the device moves. For example, if the client 104A is walking along a roadway, the communication area 202A will move as the client walks.

In this example, overlapping communication areas 202 are not used to determine whether users may connect, but rather, the location of the clients 104A-104D is the determining factor. As a result, unless a client 104 is within a given communication area 202 of another client, they will not be visible. However, as noted herein, various embodiments may permit one or more users to establish private and/or semi-private chatrooms in which any user within their given communication area can communicate with others, even if that communication would not be permitted in public chatrooms. Furthermore, users creating rooms may be able to further monitor and control interactions within the chatrooms In this example, the communication area 202A for the first client 104A does not include any of the clients 104B-104D, and as a result, the first client 104A may not be able to communicate with the clients 104B-104D (in public chatrooms). However, as noted herein, the communication area 202C for the client 104C may control the scenario in situations where the client 104C has established the chatroom and, therefore, may grant the client 104A access to chat with the client 104C, along with other clients within the communication area 202C. That is, various embodiments may only require one user to be within a communication area for another user to permit communication. In certain embodiments, the creator of the chatroom may be the user that enables the additional communications, which may be provided at a different service tier. However, other embodiments may require both communication areas to include the associated clients.

In this example, the client 104C has two different chat options, which may be public chat options. A first chat option includes the clients 104B and 104D and the second chat option includes the client 104A. Similarly, the client 104B has a chat option that includes both 104B and 104C because each of the clients 104B, 104C is within the communication area 202B for the client 104B. That is, the devices are within the region associated with the communication area 202B, and not necessarily an overlapping communication area, as noted with respect to FIG. 2A. In this manner, different clients can communicate with one another based on device location instead of overlapping communication areas, which may allow clients to further tailor and limit their searching area. For example, in the scenario of FIG. 2A, if two clients set their radius to 500 feet and they just overlap on the edges, the other client is approximately 1,000 feet away, not 500 feet. While that may provide more chatting options, the user may want their search area to be more limited, and as a result, basing the area on device location instead of overlapping communication areas may provide a more tailored search approach.

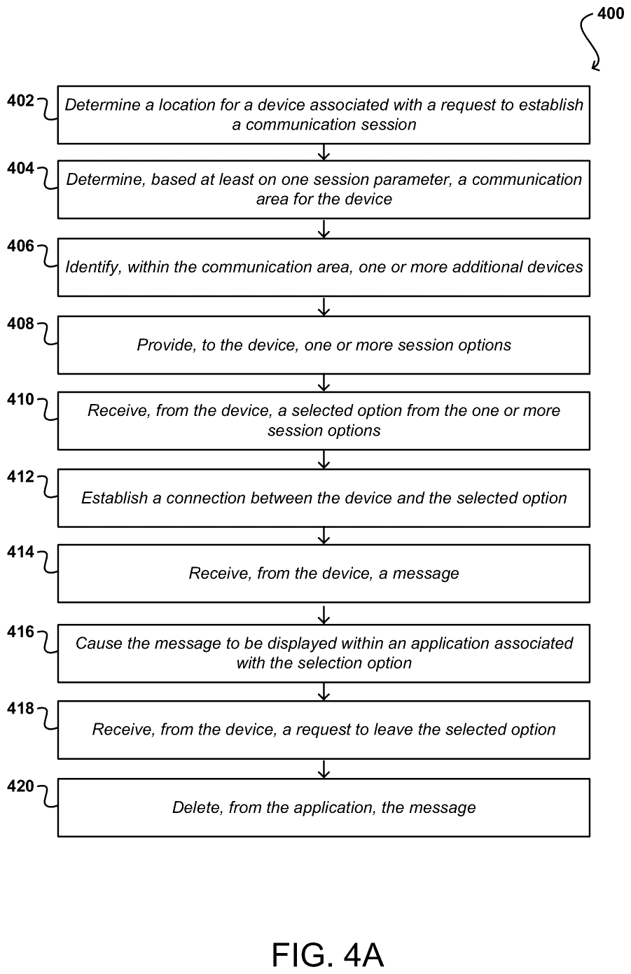

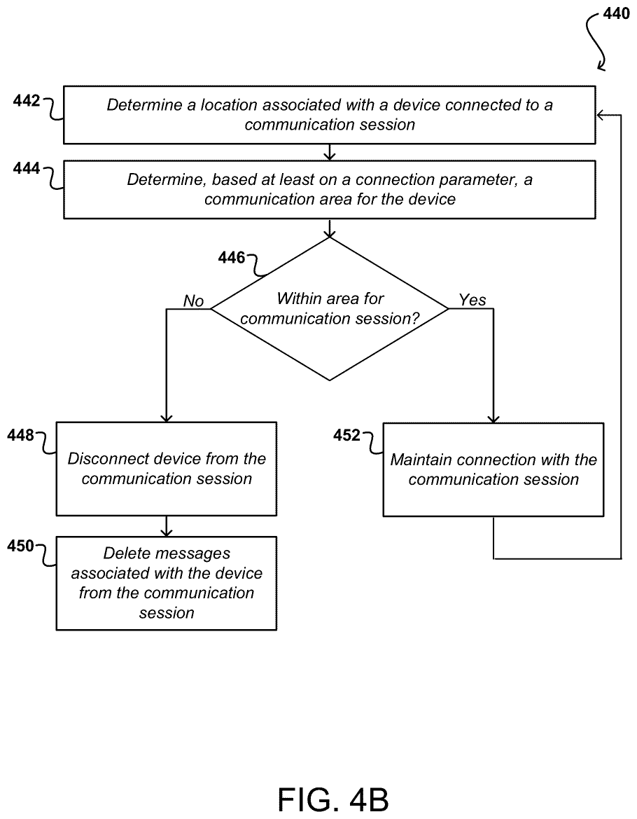

FIG. 4A is a flow chart of a method 400 for establishing a proximity-based chat communication. It should be appreciated that steps for the method may be performed in any order, or in parallel, unless otherwise specifically stated. Moreover, the method may include more or fewer steps. In this example, a location for a device is determined 402. The location may be determined responsive to a request to establish a communication session. For example, the user may log into a proximity-based chat application and request to start using the application to chat with other users. In various embodiments, a communication area for the device may be determined 404. The determination area for the device may be determined based on factors such as a desired radius set by the user, a radius set by a tier associated with a user subscription, an area in which the device is located, and/or combinations thereof. For example, if the user is at an event, the communication area may include an entire area associated with the event.

One or more additional devices within the communication area may be identified 406 and the device may be provided with one or more session options 408. The session options may include different interaction areas, such as chatrooms, in which the device may interact with the other users identified within the communication area. The device may select an option from the session options 410 and a connection between the device and selected option may be established 412, such as by adding the device to a chatroom. The device may then provide a message 414 which is displayed within an application associated with the connection 416. Upon receiving a request to leave the selected option 418, the message sent by the device may be deleted from the application 420.

FIG. 4B is a flow chart of a method 440 for maintaining a proximity-based chat communication. In this example, a location is determined for a device connected to a communication session 442. For example, as noted herein, one or more location services may be used to determine whether a location for the device satisfies one or more criterion for being included within the communication session. A communication area, for example, may be determined based on different connection parameters 444 and, using the communication area, it may be determined whether or not associated users for the communication session are within a designated area to permit communication with the device 446. If not, then the device may be disconnected from the communication session 448 and associated messages from the device in the communication session may be deleted 450. If the device is within the communication area, the connection may be maintained 452. In this manner, users may be removed from communication sessions as they move outside of different communications areas.

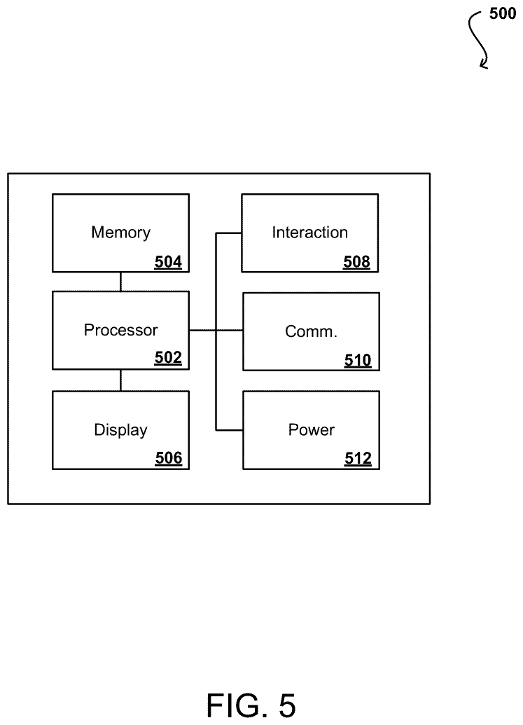

FIG. 5 illustrates a set of general components of an example computing device 500. In this example, the device includes a processor 502 for executing instructions that can be stored in a memory 504. The device can include many types of memory, data storage, or non-transitory computer-readable storage media, such as a first data storage for program instructions for execution by the processor 502, a separate storage for images or data, a removable memory for sharing information with other devices, etc. The device may optionally include a display element 506, such as a touch screen or liquid crystal display (LCD), although devices such as portable media players might convey information via other means, such as through audio speakers, and other devices may not include displays, such as server components executing within data centers, among other options. As discussed, the device in many embodiments will include at least one interaction component 508 able to receive input from a user. This input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device. In some embodiments, the computing device 500 of FIG. 5 can include one or more network interface or communication components 510 for communicating over various networks, such as a Wi-Fi, Bluetooth, RF, wired, or wireless communication systems. The device may be configured to communicate with a network, such as the Internet, and may be able to communicate with other such devices. The device will also include one or more power components 512, such as power cords, power ports, batteries, wirelessly powered or rechargeable receivers, and the like.

Storage media and other non-transitory computer readable media for containing code, or portions of code, can include any appropriate media known or used in the art, including storage media and communication media, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

Embodiments may also be described in view of the following clauses:
1. A computer-implemented method, comprising:
receiving a request to establish a communication session, from a device;
determining, for the device, a device location;
determining, based at least on the device location, a communication area for the device;
providing, for display on the device, one or more session options associated with the request, each session options of the one or more session options corresponding to a communication session;
receiving, from the device, a selected option from the one or more session options;
establishing a connection between the device and the selected option;
receiving, from the device, a message associated with the connection and the selected option;
causing the message to be displayed for users of the selected option;
receiving, from the device, an ending indication for the communication session; and
deleting the message from the selected option for the device and associated devices of the users of the selected option.
2. The computer-implemented method of clause 1, wherein the ending indication is one or more of a request to end the communication session or a determination that the communication area for the device disqualifies the device from participating in the selected option.
3. The computer-implemented method of clause 1, wherein the communication area comprises an area associated with a radius extending from the device.
4. The computer-implemented method of clause 3, wherein the users of the selected option are within the communication area.
5. The computer-implemented method of clause 3, wherein respective communication areas for the users of the selected option overlap the communication area of the device.
6. The computer-implemented method of clause 1, wherein the selected option is at least one of a public group chat or a private chat.
7. The computer-implemented method of clause 1, wherein the request is provided to an application executed on the device.
8 The computer-implemented method of clause 1, wherein the selected option corresponds to a chat established by an anchor user of the users and an anchor user communication area is greater than the communication area for the device.
9. The computer-implemented method of clause 1, wherein the selected option corresponds to a managed chat created by an administrator.
10. A method, comprising:
determining a device location for a device participating in a proximity-based communication session;
determining, for the communication session, a connection parameter for participants of the communication session;
determining the device location fails a condition associated with the connection parameter;
disconnecting the device from the communication session; and
deleting messages associated with the device from the communication session.
11. The method of clause 10, wherein the connection parameter includes at least one of a distance between participants of the communication session, a geographic location, or an indicator.
12. The method of clause 10, wherein the condition corresponds to the device being within a threshold distance of other participants in the communication session.
13. The method of clause 12, wherein a participant of the other participant is an anchor participant and the threshold is based on an anchor participant location.
14. The method of clause 10, further comprising:
determining the device satisfies the condition; and
maintaining a connection for the device within the communication session.
15. The method of clause 10, wherein the device location is based, at least in part, on one or more proximity-based machine learning algorithms.
16. A system, comprising:
one or more processors to:
   receive a first request to establish a communication session from a device;
   determine, for the device, a device location;
   determine, based at least on the device location, a communication area for the device;
   establish, for the device, a session option to be used by additional devices within the communication area;
   receive, from a first additional device, a second request to connect to the session option;
   establish a first connection to the first additional device;
   receive from a second additional device, a third request to connect to the session option; and
   establish a second connection to the second additional device;
wherein a first additional device communication area is within the communication area, a second additional device communication area is within the communication area, and the first additional device communication area and the second additional device communication area do not overlap.
17. The system of clause 16, wherein the communication area comprises an area associated with a radius extending from the device.
18. The system of clause 16, wherein the one or more processors are further to:
determine, based on a first additional device location, that the first additional device is outside communication area; and
end the first connection.
19. The system of clause 16, wherein the session option is at least one of a public group chat or a private chat.
20. The system of clause 16, wherein the session option corresponds to an anonymous communication area for each of the device, the first additional device, and the second additional device.
21. A computer-implemented method, comprising:
receiving a request to establish a communication session, from a device;
determining, for the device, a device location;
determining, based at least on the device location, a communication area for the device;
providing, for display on the device, one or more session options associated with the request, each session options of the one or more session options corresponding to a communication session;
receiving, from the device, a selected option from the one or more session options;
establishing a connection between the device and the selected option;
receiving, from the device, a message associated with the connection and the selected option;
causing the message to be displayed for users of the selected option;
receiving, from the device, an ending indication for the communication session; and
deleting the message from the selected option for the device and associated devices of the users of the selected option.
22. The computer-implemented method of clause 21, wherein the ending indication is one or more of a request to end the communication session or a determination that the communication area for the device disqualifies the device from participating in the selected option.
23. The computer-implemented method of any of clauses 21 or 22, wherein the communication area comprises an area associated with a radius extending from the device.
24. The computer-implemented method of clause 23, wherein the users of the selected option are within the communication area.
25. The computer-implemented method of clause 23, wherein respective communication areas for the users of the selected option overlap the communication area of the device.
26. The computer-implemented method of any of clauses 21-25, wherein the selected option is at least one of a public group chat or a private chat.
27. The computer-implemented method of any of clauses 21-26, wherein the request is provided to an application executed on the device.
28. The computer-implemented method of any of clauses 21-27, wherein the selected option corresponds to a chat established by an anchor user of the users and an anchor user communication area is greater than the communication area for the device.
29. The computer-implemented method of clause any of clauses 21-28, wherein the selected option corresponds to a managed chat created by an administrator.
30. A method, comprising:
determining a device location for a device participating in a proximity-based communication session;
determining, for the communication session, a connection parameter for participants of the communication session;
determining the device location fails a condition associated with the connection parameter;
disconnecting the device from the communication session; and
deleting messages associated with the device from the communication session.
31. The method of clause 30, wherein the connection parameter includes at least one of a distance between participants of the communication session, a geographic location, or an indicator.
32. The method of any of clauses 30 or 31, wherein the condition corresponds to the device being within a threshold distance of other participants in the communication session.
33. The method of clause 32, wherein a participant of the other participant is an anchor participant and the threshold is based on an anchor participant location.
34. The method of any of clauses 31-33, further comprising:
determining the device satisfies the condition; and
maintaining a connection for the device within the communication session.
35. The method of any of clauses 31-34, wherein the device location is based, at least in part, on one or more proximity-based machine learning algorithms.
36. A system, comprising:
one or more processors to:
   receive a first request to establish a communication session from a device;
   determine, for the device, a device location;
   determine, based at least on the device location, a communication area for the device;
   establish, for the device, a session option to be used by additional devices within the communication area;
   receive, from a first additional device, a second request to connect to the session option;
   establish a first connection to the first additional device;
   receive from a second additional device, a third request to connect to the session option; and
   establish a second connection to the second additional device;
wherein a first additional device communication area is within the communication area, a second additional device communication area is within the communication area, and the first additional device communication area and the second additional device communication area do not overlap.
37. The system of clause 36, wherein the communication area comprises an area associated with a radius extending from the device.
38. The system of any of clauses 36 or 37, wherein the one or more processors are further to:
determine, based on a first additional device location, that the first additional device is outside communication area; and
end the first connection.
39. The system of any of clauses 36-38, wherein the session option is at least one of a public group chat or a private chat.
40. The system of any of clauses 36-39, wherein the session option corresponds to an anonymous communication area for each of the device, the first additional device, and the second additional device.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A computer-implemented method, comprising:
receiving a request to establish a communication session, from a device;
determining, for the device, a device location;
determining, based at least on the device location, a communication area for the device;
providing, for display on the device, one or more session options associated with the request, each session options of the one or more session options corresponding to a communication session;
receiving, from the device, a selected option from the one or more session options;
establishing a connection between the device and the selected option;
receiving, from the device, a message associated with the connection and the selected option;
causing the message to be displayed for users of the selected option;
receiving, from the device, an ending indication for the communication session; and
deleting the message from the selected option for the device and associated devices of the users of the selected option.

2. The computer-implemented method of claim 1, wherein the ending indication is one or more of a request to end the communication session or a determination that the communication area for the device disqualifies the device from participating in the selected option.

3. The computer-implemented method of claim 1, wherein the communication area comprises an area associated with a radius extending from the device.

4. The computer-implemented method of claim 3, wherein the users of the selected option are within the communication area.

5. The computer-implemented method of claim 3, wherein respective communication areas for the users of the selected option overlap the communication area of the device.

6. The computer-implemented method of claim 1, wherein the selected option is at least one of a public group chat or a private chat.

7. The computer-implemented method of claim 1, wherein the request is provided to an application executed on the device.

8. The computer-implemented method of claim 1, wherein the selected option corresponds to a chat established by an anchor user of the users and an anchor user communication area is greater than the communication area for the device.

9. The computer-implemented method of claim 1, wherein the selected option corresponds to a managed chat created by an administrator.

10. A method, comprising:
determining a device location for a device participating in a proximity-based communication session;
determining, for the communication session, a connection parameter for participants of the communication session;
determining the device location fails a condition associated with the connection parameter;
disconnecting the device from the communication session; and
deleting messages associated with the device from the communication session.

11. The method of claim 10, wherein the connection parameter includes at least one of a distance between participants of the communication session, a geographic location, or an indicator.

12. The method of claim 10, wherein the condition corresponds to the device being within a threshold distance of other participants in the communication session.

13. The method of claim 12, wherein a participant of the other participant is an anchor participant and the threshold is based on an anchor participant location.

14. The method of claim 10, further comprising:
determining the device satisfies the condition; and
maintaining a connection for the device within the communication session.

15. The method of claim 10, wherein the device location is based, at least in part, on one or more proximity-based machine learning algorithms.

16. A system, comprising:
one or more processors to:
receive a first request to establish a communication session from a device;
determine, for the device, a device location;
determine, based at least on the device location, a communication area for the device;
establish, for the device, a session option to be used by additional devices within the communication area;
receive, from a first additional device, a second request to connect to the session option;
establish a first connection to the first additional device;
receive from a second additional device, a third request to connect to the session option; and
establish a second connection to the second additional device;
wherein a first additional device communication area is within the communication area, a second additional device communication area is within the communication area, and the first additional device communication area and the second additional device communication area do not overlap.

17. The system of claim 16, wherein the communication area comprises an area associated with a radius extending from the device.

18. The system of claim 16, wherein the one or more processors are further to:
determine, based on a first additional device location, that the first additional device is outside communication area; and
end the first connection.

19. The system of claim 16, wherein the session option is at least one of a public group chat or a private chat.

20. The system of claim 16, wherein the session option corresponds to an anonymous communication area for each of the device, the first additional device, and the second additional device.
